(19) United States
(12) Patent Application Publication
(10) Pub. No.: US 2024/0227960 A1
(43) Pub. Date: Jul. 11, 2024

(54) DISPLAYS FOR VEHICLE SUPPORT STANDS AND SYSTEMS ASSOCIATED THEREWITH

(71) Applicant: Matthew I DeIulio, Greenville, SC (US)

(72) Inventors: Matthew I DeIulio, Greenville, SC (US); David M DeIulio, Salem, SC (US); Maureen S DeIulio, Salem, SC (US)

(21) Appl. No.: 18/563,887

(22) PCT Filed: Jun. 1, 2022
(86) PCT No.: PCT/US22/31820

§ 371 Date: Nov. 23, 2023

Related U.S. Application Data
(60) Provisional application No. 63/195,752, filed on Jun. 2, 2021.

(51) Int. Cl. B62H 1/02; B62J 50/40

(52) U.S. Cl. CPC B62H 1/02; B62J 50/40

(57) ABSTRACT

Displays for vehicle support stands and systems associated therewith are provided. A system for coupling a display having artistic value to a support stand of a vehicle generally includes the display; and an attachment mechanism configured to couple the display to the support stand, wherein the display is adjustably positionable relative to the support stand with at least three degrees of freedom.

### CROSS-REFERENCE TO RELATED APPLICATIONS

The present application claims priority to filed on U.S. Provisional Patent Application 63/195,752 filed on Jun. 2, 2021, the disclosure of which is incorporated by reference herein in its entirety.

### FIELD

The present disclosure relates generally to devices for use with vehicle support stands, and more particularly to visual displays and systems associated therewith for vehicle support stands.

### BACKGROUND

Vehicles, such as motorcycles, scooters, bicycles, and the like, typically include support stands, such as kick stands or center stands, upon which the vehicle (or a portion of the vehicle) can rest, e.g., when not in active use. Support stands are usually elongated members. Support stands can be pivotably coupled to a frame of the vehicle and movable between in-use positions, i.e., deployed positions where the vehicle can rest upon the support stand, and stored positions where the support stand does not interfere with operation of the vehicle.

Support stands are often an afterthought for manufacturers given their purely functional role and cost considerations. However, personalization of vehicles is increasingly desired with many owners adorning their vehicles with aftermarket parts.

Support stands come in a wide variety of different shapes and sizes, operating under different kinematic motion profiles, with different spatial limitations, constraints, and considerations. Thus, personalization of support stands has not been previously considered.

Accordingly, improved systems and methods of personalizing support stands are desired in the art.

### BRIEF DESCRIPTION

Aspects and advantages of the invention in accordance with the present disclosure will be set forth in part in the following description, or may be obvious from the description, or may be learned through practice of the technology.

In accordance with one embodiment, a system for coupling a display having artistic value to a support stand of a vehicle is provided. The system includes a display; and an attachment mechanism configured to couple the display to the support stand, wherein the display is adjustably positionable relative to the support stand with at least three degrees of freedom.

In accordance with another embodiment, a system for coupling a display having artistic value to a support stand of a vehicle is provided. The system includes a display; and an attachment mechanism configured to couple the display to the support stand, wherein the display is selected from a plurality of displays each having a different appearance, and wherein at least two of the plurality of displays are configured to be coupled to the attachment mechanism without requiring movement of the attachment mechanism relative to the support stand.

In accordance with another embodiment, a system for coupling a display having artistic value to a support stand of a vehicle is provided. The system includes a display; and an attachment mechanism configured to couple the display to the support stand, wherein the display is adjustable relative to the attachment mechanism with at least one degree of freedom, and wherein an interface between the display and attachment mechanism is disposed within an outer boundary of the display.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a side view of a portion of a vehicle including a system in accordance with embodiments of the present disclosure as seen with a support stand of the vehicle in a stored position;

FIG. 2 is a side view of a portion of the vehicle including the system in accordance with embodiments of the present disclosure as seen with the support stand of the vehicle in the in-use position;

FIG. 3 is a side view of a portion of another vehicle including the system in accordance with embodiments of the present disclosure as seen with the support stand of the vehicle in the stored position;

FIG. 4 is a front view of a portion of yet another vehicle including a portion of the system in accordance with embodiments of the present disclosure as seen with the support stand of the vehicle in the in-use position;

FIG. 5 is a perspective view of an attachment mechanism of the system in accordance with embodiments of the present disclosure;

FIG. 6 is a rear view of a portion of yet another vehicle including the system in accordance with embodiments of the present disclosure as seen with the support stand of the vehicle in the in-use position;

FIG. 7 is a rear view of a display of the system in accordance with embodiments of the present disclosure;

FIG. 8 is a cross-sectional view of the display in accordance with embodiments of the present disclosure as seen along Line A-A in FIG. 7;

FIG. 9 is a cross-sectional view of the display in accordance with embodiments of the present disclosure as seen along Line B-B in FIG. 7;

FIG. 10 is a rear view of a portion of another vehicle including the system in accordance with embodiments of the present disclosure as seen with the support stand of the vehicle in the in-use position;

FIG. 11 is a top perspective view of an attachment mechanism in accordance with embodiments of the present disclosure;

FIG. 12 is a side view of the vehicle including the system in accordance with embodiments of the present disclosure as seen with the support stand of the vehicle in the in-use position; and

FIG. 13 illustrates a flowchart of a method of installing a system having a display on a support stand in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially” are intended to include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, embodiments described herein are directed to systems and methods for coupling displays, i.e., artwork with artistic value (e.g., three-dimensional reliefs, three-dimensional sculptures, two-dimensional reliefs, and the like), to support stands of vehicles. Exemplary vehicles include motorcycles, scooters, mopeds, bicycles, electric bicycles often referred to as e-bikes, and the like. When not in active use, these vehicles may be supported by selectively deployable, integrated support stands, such as side stands and center stands. Given the wide range of vehicles on the market which each utilize a different type and style of support stand, universal attachment of displays to support stands requires an adaptable system whereby the display can be moved and repositioned to accommodate a wide range of spatial considerations associated with each vehicle.

The following examples are some of the restrictions which limit universal attachment to support stands. Some support stands include a projecting peg to allow easier access and deployment of the support stand. Known projecting pegs extend from different positions along the support stand at different relative angles. To deploy the support stand, the operator uses their foot to engage the projecting peg instead of directly engaging the support stand itself as the remainder of the support stand may be inaccessible from the riding position. Some support stands include bumpers that prevent the support stand from harshly impacting a frame of the vehicle when moved to the stored position. These bumpers can be disposed at any position along the support stand but are often disposed within a known cluster of locations located proximate to a lower end of the support stand. Some support stands include tapered profiles, unique cross-sectional shapes, or variable diameters. Some support stands rest within small, irregular shaped volumes of the vehicle when in the stored position. Support stands typically include exposed springs which can be positioned at, and coupled to, the support stand at a wide variety of locations. Different support stands exhibit different kinematic motion profiles between the in-use (e.g., deployed) position and the stored position. For example, some support stands pivot about a generally horizontal rotational axis while other support stands pivot about a generally vertical rotational axis. As a result of these different kinematic motion profiles, the various surfaces and sides of the support stand transpose differently between the in-use and stored positions, thus creating different spatial considerations for the display.

In accordance with embodiments described herein, a universal system for coupling a display to a support stand is provided. The system can include an attachment mechanism for coupling the display to the support stand. The attachment mechanism can allow for adjustable positioning of the display relative to the support stand. Thus, the display may be used on a wide variety of different support stands each having a unique shape, size, configuration and spatial requirement.

In accordance with embodiments described herein, the display may be removable from the attachment mechanism while the attachment mechanism remains coupled to the support stand. In such a manner, the rider can change between two or more different displays, e.g., swap displays, without removing the attachment mechanism from the support stand. However, the attachment mechanism may also be removable from the support stand to allow for replacement or repositioning of the attachment mechanism.

These and other advantages of the systems and methods described herein will become apparent to one of ordinary skill in the art after reading the entire disclosure contained herein.

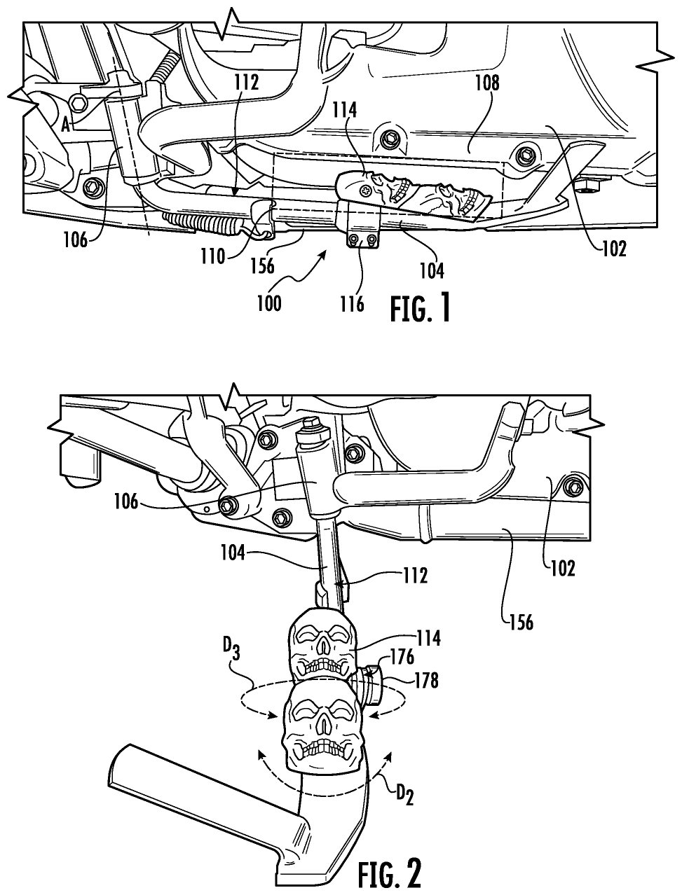

Referring now to the drawings, FIG. 1 illustrates a side view of a portion of a motorcycle 102 as seen with a support stand 104 in the stored position, e.g., when the motorcycle 102 is being driven. The support stand 104 is rotatable between the depicted stored position and an in-use position (illustrated in FIG. 2) through a pivot point 106. For the motorcycle 102 depicted in FIG. 1, the pivot point 106 exhibits rotation about a generally vertical rotational axis A.

For the motorcycle 102 depicted in FIG. 1, the support stand 104 is disposed below structure 108 of the motorcycle 102 in the stored position. For example, the support stand 104, or a portion thereof, can be tucked beneath one or more components, such an engine or transmission, of the motorcycle 102. Limitations associated with a space 110 formed between the structure 108 and a nearest surface 112 of the support stand 104 in the stored position may limit one or more characteristics, such as size, of a display 114 to be coupled to the support stand 104. In an embodiment, the surface 112 of the support stand 104 may correspond with a surface nearest to the display 114.

FIG. 2 depicts a view of the support stand 104 in the deployed, in-use position as seen when the motorcycle 102 is supported by the support stand 104. Since the support stand 104 rotates about a pivot point 106 having a generally vertical rotational axis A, the surface 112 of the support stand 104 remains the upper surface in both the stored and in-use positions. In this regard, the display 114 is disposed above the support stand 104 in both the stored and in-use positions.

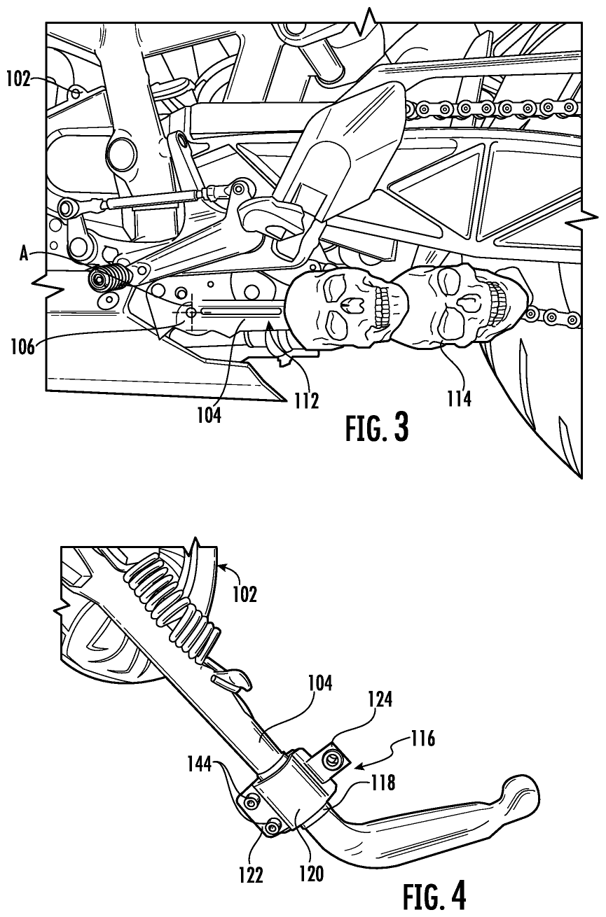

FIG. 3 depicts a side view of a different motorcycle 102 having a support stand 104 which rotates about a pivot point 106 with a generally horizontal rotational axis A. The support stand 104 depicted in FIG. 3 is in the stored position. As compared to the support stand 104 depicted in FIGS. 1 and 2 in which the surface 112 remain an upper surface in both the in-use and stored positions, the same surface 112 of the support stand 104 depicted in FIG. 3, i.e., the surface of the support stand 104 nearest to the display 114, remains a side surface of the support stand 104 in both the in-use and stored positions. Yet other rotational axis A are known to exist, each having a different kinematic movement profile.

As previously described, these different kinematic movement profiles make universal attachment of displays 114 to the support stand 104 difficult to achieve as spatial considerations are different for every type of kinematic movement profile. The present disclosure overcomes these and other limitations by providing a system 100 (FIG. 1) having an adjustable interface for adjustably coupling the display 114 to the support stand 104. The system 100 can generally include an attachment mechanism 116 which selectively couples the display 114 to the support stand 104.

FIG. 4 illustrates the attachment mechanism 116 in accordance with an exemplary embodiment of the present disclosure as seen coupled to the support stand 104 of yet another motorcycle 102. The attachment mechanism 116 extends around at least a portion, such as all, of a circumference of the support stand 104. The attachment mechanism 116 can be coupled to the support stand 104 in a manner to prevent relative rotation between the attachment mechanism 116 and the support stand 104.

In certain instances, the attachment mechanism 116 may be directly coupled to the support stand 104. In other instance, an intermediary element, such as, e.g., a rubber tape 118, can be disposed between the attachment mechanism 116 and the support stand 104. In an embodiment, the rubber tape 118 can be installed on the support stand 104 prior to coupling the attachment mechanism 116 to the support stand 104. In an embodiment, the rubber tape 118 can include a self-amalgamating or adhesive backed tape. The rubber tape 118 can be wrapped around the support stand 104 at least once to form a single ply or multi-ply buffer between the support stand 104 and attachment mechanism 116. Use of additional plies may increase the effective diameter of the support stand 104, thereby allowing the attachment mechanism 116 to be utilized with support stands 104 having relatively small diameters. In certain instances, the rubber tape 118 can prevent the attachment mechanism 116 from marring the support stand 104. In some instances, the rubber tape 118 can be replaced, or supplemented, with a shaped insert configured to be disposed between the support stand 104 and the attachment mechanism 116.

In an embodiment, the attachment mechanism 116 can include an interface portion 120 which interfaces with the support stand 104, a fastening portion 122 which selectively secures the interface portion 120 to the support stand 104, and an engagement portion 124 which engages with the display 114 (FIGS. 1 to 3).

In an embodiment, the attachment mechanism 116 is installed on the support stand 104 prior to attaching the display 114 thereto. In another embodiment, the attachment mechanism 116 is coupled to the display 114 prior to attaching the attachment mechanism 116 to the support stand 104.

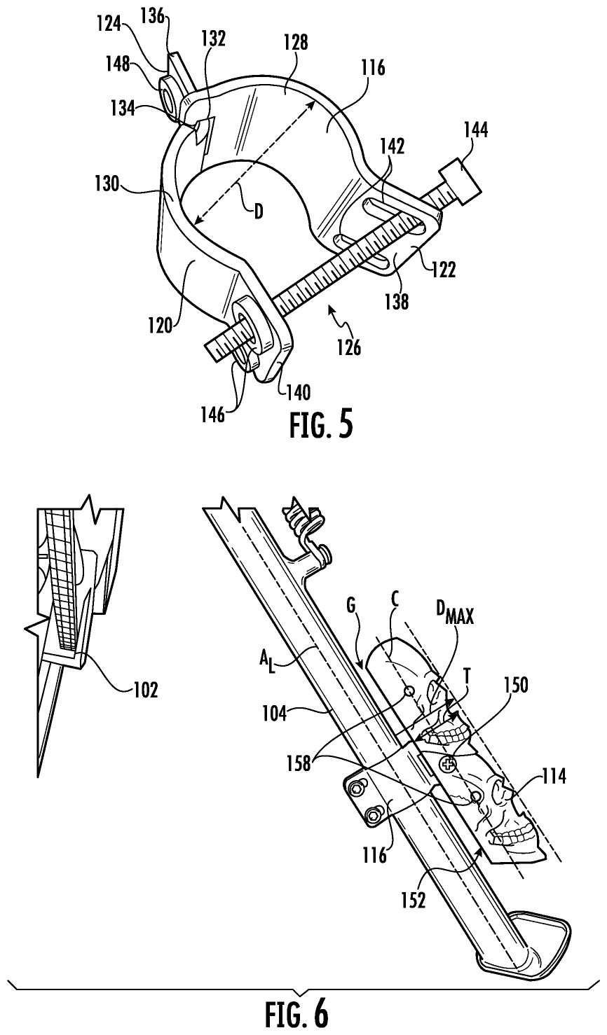

FIG. 5 illustrates a perspective view of an exemplary attachment mechanism 116 as seen detached from the support stand 104 in an open position whereby the interface portion 120 is ready to receive the support stand 104 through an opening 126. In an embodiment, the interface portion 120 can have a circular shape to receive the support stand 104. In other embodiments, the interface portion 120 can have a polygonal shape (e.g., a triangular shape, a quadrilateral shape, a pentagonal shape), a shape with one or more linear features, a shape with one or more arcuate features, or the like.

In an embodiment, the attachment mechanism 116 includes one or more relatively rigid portions formed from a resilient material, such as a metal, e.g., steel, or a plastic. In another embodiment, the attachment mechanism 116 can include one or more relatively flexible portions. By way of example, the relatively rigid portions can provide structural support for the display 114 while the relatively flexible portions can permit installation of the system 100 on various types of support stands 104.

In an embodiment, the attachment mechanism 116 comprises a multi-piece construction including, for example, a first component 128 and a second component 130. The first and second components 128 and 130 can together form the interface portion 120. In an embodiment, the first and second components 128 and 130 can be movably coupled together at an interface 132. The depicted interface 132 includes an opening 134 in the first component 128 through which a post 136 of the second component 130 extends. In certain instances, the interface 132 can be configured to prevent detachment of the first and second components 128 and 130 from one another while permitting relative movement therebetween. For example, the second component 130 can pivot relative to the first component 128 about an axis formed by the opening 134. Relative movement between the first and second components 128 and 130 can allow an effective size, e.g., a diameter D, of the interface portion 120 to accommodate support stands 104 of various dimensions and allow the opening 134 to expand to accept the support stand 104 during installation.

By way of non-limiting example, the fastening portion 122 can include a first flange 138 on the first component 128 and a second flange 140 on the second component 130. After passing the support stand 104 through the opening 126 such that the support stand 104 is located at least partially within the interface portion 120 of the attachment mechanism 116, the flanges 138 and 140 can be drawn together to close the opening 126 and reduce the diameter D of the interface portion 120 to form a snug fit with the support stand 104. In certain instances, the attachment mechanism 116 can begin to deform as the flanges 138 and 140 are drawn tight together.

In an embodiment, each of the first and second flanges 138 and 140 can include one or more openings 142 configured to receive one or more fasteners 144. The openings 142 of the second component 130 can include receiving element(s), e.g., nut(s) 146, that engage the fastener(s) 144. In an embodiment, the nut(s) 144 can be fixed, e.g., captured, to prevent rotation. The fastener(s) 144 can extend between opening(s) 142 of the first flange 138 and opening(s) 142 of the second flange 140 to selectively draw the flanges 138 and 140 together. The openings 142 in the first component 128 are depicted as elongated slots. The fastener(s) 144 can move within the elongated slots to accommodate various sized support stands 104.

As described above, the engagement portion 124 can interface with the display 114 to selectively couple the display 114 to the attachment mechanism 116. The post 136 can include an engagement mechanism configured to selectively engage the display 114. By way of non-limiting example, the engagement mechanism can include a nut 148. Referring to FIG. 6, a fastener 150 (e.g., a threaded fastener) can interface with the nut 148 to selectively couple the display 114 to the attachment mechanism 116. Other engagement protocols between the attachment mechanism 116 and display 114 are contemplated herein without deviating from the scope of the invention. For instance, the engagement portion 124 can interface with the display 114 via a bayonet connection, a snap connection, a ball detent interface (see FIG. 11), a ball and socket interface, a cotter pin or other non-threaded fastener, an interference fit, a magnetic interface, an adhesive, a displaceable latch, an integral threaded rod and threaded hole, or the like. In certain instance, the attachment mechanism 116 can form a quick connect interface with the display 114. The quick connect interface can result in the display 114 being removable from, or installable on, the attachment mechanism 116 in less than 60 seconds, such as less than 30 seconds, such as less than 10 seconds.

In some instances, the display 114 can be coupled to the attachment mechanism 116 without the use of tools, allowing for toolless installation. In other instances, the display 114 can be coupled to the attachment mechanism 116 using one or more tools, such as a screwdriver or an allen wrench. In an embodiment, the display 114 can be coupled to the support stand 104 in a non-destructable manner. Thus, the display 114 and attachment mechanism 116 can be used repeatedly without requiring replacement of any parts. Moreover, non-destructable attachment allows the installer to realign the display 114 or the attachment mechanism 116 without requiring destruction of components of the system.

In an embodiment, the attachment mechanism 116 can include a bumper (not illustrated) configured to contact the motorcycle 102, e.g., when the system 100 is in the stored position. The bumper may be statically fixed to the attachment mechanism 116 or adjustable relative thereto.

FIG. 11 depicts an attachment mechanism 1100 in accordance with another exemplary embodiment of the present disclosure. The attachment mechanism 1100 includes a first component 1102 and a second component 1104 similar to the attachment mechanism 116 previously described. However, the first and second components 1102 and 1104 are not coupled together at the interface 132 and are entirely separable from one another. The first component 1102 includes a first flange 1106 and a second flange 1108 and the second component 1104 includes a third flange 1110 and a fourth flange 1112. The first and third flanges 1106 and 1110 can be coupled together and the second and fourth flanges 1108 and 1112 can be coupled together using fasteners 1114. In certain instances, the fasteners 1114 can be engaged with nuts 1116 coupled to the second component 1104. The nuts 1116 can be captured or otherwise retained to prevent rotation during engagement and disengagement with the fasteners 1114. The first and second components 1102 and 1104 can together define an interface portion 1118 similar to the interface portion 120 for interfacing with the support stand 104 and the flanges 1106, 1108, 1110 and 1112 can define a fastening portion 1120 similar to the fastening portion 122.

In an embodiment, the attachment mechanism 1100 includes an engagement portion 1122 that is removable from the first and second components 1102 and 1104. By way of example, the engagement portion 1122 can be coupled to the first component 1102 through one or more of the fasteners 1114. This can allow the engagement portion 1122 to be swapped between a plurality of engagement portions 1122, reoriented between a plurality of positions, or the like. The depicted engagement portion 1122 includes a post 1124 with a ball detent 1126 which interfaces with the display 114 (FIG. 1) to retain the display at the support stand 104. In certain instances, the ball detent 1126 can be passive and require only application of force to, e.g., the display 114, to release the display 114 therefrom. In other instances, the ball detent 1126 can be active and require a user to initiate a release protocol in addition to simply moving the display 114. By way of non-limiting example, the ball detent 1126 may be coupled to a depressible button which releases the ball detent 1126 from the display 114 when the button is depressed. The ball detent 1126 is a non-limiting example of a quick release engagement portion 1122. It should be understood that the disclosure is not limited to the exemplary embodiments described above and that other fastening protocols are contemplated herein without deviating from the scope of the disclosure. For example, in a non-illustrated embodiment, the attachment mechanism 116 (or a portion thereof) can be at least partially integrated into the support stand 104, at least partially integrated into the display 114, or both.

FIG. 6 illustrates a view of the display 114 coupled to the support stand 104 of yet another motorcycle 102. The display 114 is coupled to the attachment mechanism 116 using the aforementioned, exemplary fastener 150. The fastener 150 can extend through at least a portion of the display 114 and engage with the engagement portion 124 (FIG. 5) of the attachment mechanism 116. The head of the fastener 150 can be countersunk into the display 114 to reduce drag or wind-induced noise while moving. In some instances, the head of the fastener 150 can be covered, e.g., by a removable cap. As described below, the display 114 may include multiple areas where the fastener 150 can be used. In some instances, the non-used areas can be covered, e.g., by a removable cap, when not actively in use.

While not illustrated, a channel can extend into the display 114 from a rear surface 152 of the display 114. In certain instances, the channel can extend parallel with a longitudinal axis A_{L} of the support stand 104. The support stand 104 may nest at least partially within the channel. In some instances, nesting may occur only when the display 114 is oriented at one or more particular angles relative to the support stand 104. In other instances, nesting may occur at all relative angles. Inclusion of the channel can reduce a maximum distance D_{MAX} that the display 114 extends away from the support stand 104 without requiring a reduction of the thickness T of the display 114. In some instances, the display 114 can be entirely spaced apart from the support stand 104 by a gap G. In a more particular instance, the display 114 may contact only the attachment mechanism 116. That is, for example, the display 114 may not contact another portion of the motorcycle 102. In other instances, one or more portions of the display 114 can contact the support stand 104, another portion of the motorcycle 102, or both.

In an embodiment, the display 114 can be coupled to the support stand 104 with at least one degree-of-freedom (DOF), such as at least two DOF, such as at least three DOF, such as at least four DOF, such as at least five DOF, such as at least six DOF, such as at least seven DOF. In certain instances, multi-DOF engagement can include one or more DOF between the display 114 and the attachment mechanism 116 and one or more DOF between the attachment mechanism 116 and the support stand 104. In other instances, all DOF may occur between either the display 114 and the attachment mechanism 116 or the attachment mechanism 116 and the support stand 104. Multi-DOF engagement can enable use of the display 114 with a wide variety of motorcycles 102, vehicles, and other objects. By way of example, a first DOF can include rotation of the display 114 around an axis corresponding with the longitudinal axis A_{L} of the support stand. A second DOF can include translation of the display 114 in a direction parallel with the longitudinal axis A_{L} of the support stand 104. The following description provides additional exemplary DOF between the display 114 and the support stand 104. It should be understood that DOF refers to adjustability in arriving at a static (e.g., selectively fixed) position of the display 114 relative to the support stand 104 and does not include dynamic movement of the display 114 once coupled to the support stand 104 as described in greater detail below.

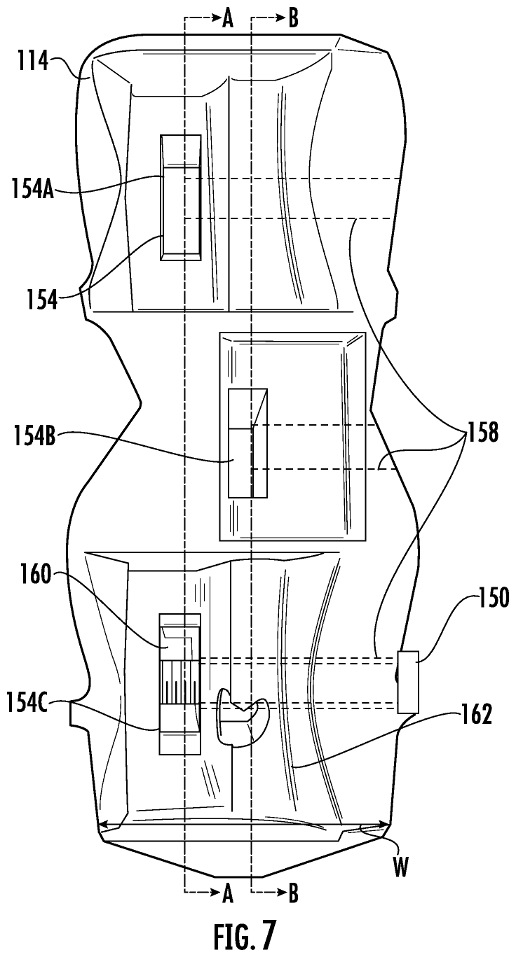

FIG. 7 depicts a rear view of the display 114 in accordance with an exemplary embodiment of the present disclosure. The display 114 can include attachment protocol, such as one or more mounting positions 154. The display 114 can be selectively coupled to the attachment mechanism 116, e.g., the post 136, at one or more of the mounting positions 154.

The depicted display 114 includes three mounting positions 154A, 154B and 154C each formed by a pocket extending into the display 114 from the rear surface 150. Other displays 114 can include different numbers of mounting positions 154, such as one mounting position, two mounting positions, four mounting positions, or more. Selection of the appropriate mounting position 154A, 154B or 154C may be at least partially based on the desired placement of the display 114 relative to the support stand 104 and limitations associated therewith.

The mounting position 154B is generally centralized relative to a width direction W of the display 114. The mounting positions 154A and 154C are both illustrated lying along a first line laterally offset from the mounting position 154B. Some support stands 104 (like the support stand 104 shown in FIGS. 1 and 2) are disposed adjacent to features, like a frame 156 (FIGS. 1 and 2), of the motorcycle 102 in the stored position. For these support stands 104, use of a laterally offset mounting position 154 may prevent the display 114 from contacting the feature, e.g., the frame 156, when the support stand 104 is in the stored position. Other support stands 104 (like the support stand 104 shown in FIG. 3) are not disposed near features of the motorcycle 102 in the stored position. For these support stands 104, use of a centralized mounting position 154B may be desirable to center the display 114 relative to the support stand 104. While not depicted, yet other mounting positions are possible in both the lateral and vertical directions. For example, two or more of the mounting positions 154 can be disposed along a same line extending, e.g., in the width direction W, to allow a single fastener 150 to be used with a plurality of different mounting positions 154.

As described above, the mounting positions 154 can each include a pocket, e.g., a recess, extending into the display 114. At least one of the pockets, such as each of the pockets, can be in fluid communication with an opening 158 which allows a mechanism, e.g., the fastener 150, to extend into the pocket to selectively engage the engagement portion 124 of the attachment mechanism 116. In an embodiment, at least two of the openings 158 can extend from a same side of the display 114. In another embodiment, at least two of the openings 158 can extend from different sides of the display 114.

In an embodiment, at least one of the mounting positions 154 can have a multi-tiered depth. For instance, at least one of the mounting positions 154 can define a recess 160 extending a first depth into the display 114, as measured from the rear surface 152, and a landing 162 extending a second depth into the display 114, as measured from the rear surface 152. In an embodiment, the first depth can be different from the second depth. For example, the first depth can be greater than the second depth. The recess 160 may receive the engagement portion 124, e.g., the post 136, of the attachment mechanism 116 while the landing 162 may receive a portion of the interface portion 120 (FIG. 5). This may allow the display 114 to have a low profile with respect to the support stand 104, i.e., a portion of the interface portion 120 can extend into the display 114 to reduce D_{MAX} (FIG. 6).

In an embodiment, the landing 162 may define an irregular shape. By way of non-limiting example, the landing 162 can define a generally hourglass shape or a half hourglass shape. The irregular shape of the landing 162 may allow the attachment mechanism 116 to pivot about an axis formed by the fastener 150 when the post 136 is disposed within the recess 160.

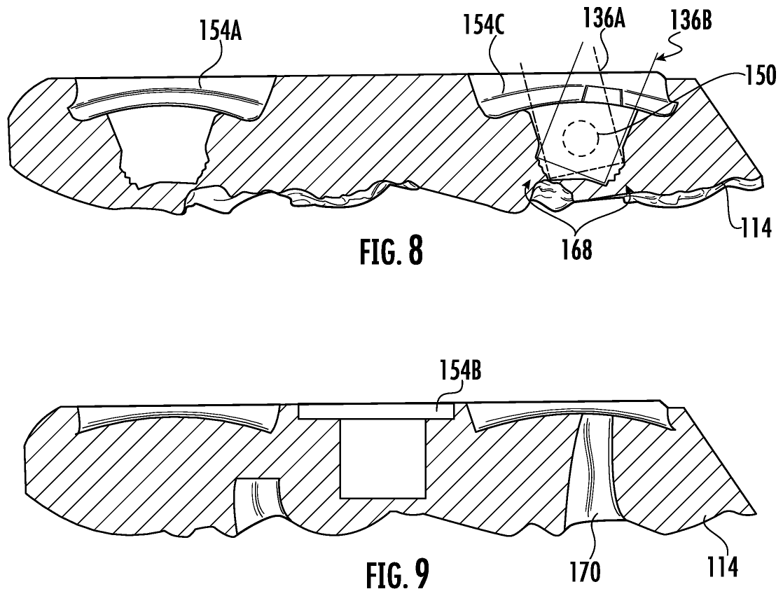

In an embodiment, at least two of the mounting positions 154 can share a common shape or size as compared to one another. In another embodiment, at least two of the mounting positions 154 can have different shapes or sizes as compared to one another. FIG. 8 depicts a cross-sectional side view of the display 114 as seen along Line A-A in FIG. 7. FIG. 9 depicts a cross-sectional side view of the display 114 as seen along Line B-B in FIG. 7. As depicted, the mounting positions 154A and 158C (FIG. 8) have the same cross-sectional shapes inverted relative to one another by 180° while the mounting position 154B (FIG. 9) has a different shape as compared to the mounting positions 154A and 154C. The mounting positions 154A and 154C can accommodate movement, e.g., pivoting, of the post 136 while the mounting position 154B receives the post 136 in a fixed, e.g., non-movable, orientation.

Referring again to FIG. 6, the mounting positions 154A, 154B and 154C are all arranged in the same general orientation relative to one another. For instance, the fastener 150 extends into each mounting position 154 in a same general orientation. Thus, selection of an appropriate mounting position 154 involves only translational displacement between the display 114 and the attachment mechanism 116. In another embodiment, at least two of the mounting positions 154 can be angularly offset from one another. In this regard, use of different mounting positions 154 can result in different angular orientations between the display 114 and the attachment mechanism 116. In yet another embodiment, one or more of the mounting positions 154 can include a plurality of different angular orientations for engaging the post 136. Use of different angular mounting positions can allow the installer to adjust the orientation of the display 114 in view of specific kinematic motion profiles of the support stand 104 and in-use positional orientations of the support stand 104 which vary between motorcycles 102. This can result, e.g., in an angular displacement in either direction D₂ or D₃ (FIG. 2).

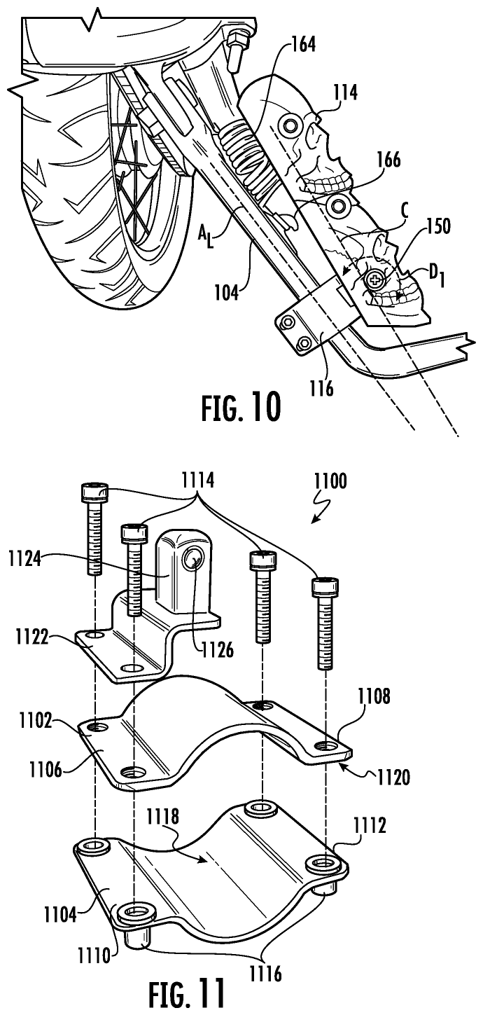

In an embodiment, the display 114 may be pivotable relative to the longitudinal axis A_{L} of the support stand 104. For example, FIG. 6 depicts a side view of the display 114 with the mounting position 154B shown coupled to the attachment mechanism 116 and a centerline C of the display 114 oriented parallel with the longitudinal axis A_{L} of the support stand 104. Meanwhile, FIG. 10 depicts a side view of the display 114 with the mounting position 154C shown coupled to the attachment mechanism 116 and the centerline C of the display 114 canted relative to the longitudinal axis A_{L}. To cant the display 114, the display 114 may be rotated in either first direction D₁ about an axis, e.g., formed by the fastener 150. The display 114 may be rotatable in either first direction D₁ by at least 1°, such as at least 5°, such as at least 10°, such as at least 25°, such as at least 45°. The depicted motorcycle 102 includes a spring 164 engaged with the support stand 104 at a projection 166. By canting the display 114 relative to the support stand 104 and utilizing the mounting position 154C, the display 114 can be coupled to the support stand 104 while avoiding the spring 164 and underlying projection 166. It should be understood that canting can occur in either direction indicated by D₁ and that canting of the display 114 may be possible from other mounting positions 154.

Referring again to FIG. 8, the display 114, e.g., at least one of the mounting positions 154, can include one or more anti-rotation features which interface with the attachment mechanism 116, e.g., at the post 136, to prevent the display 114 from undesirably rotating relative to the attachment mechanism 116, e.g., about the axis of the fastener 150. In the depicted embodiment, the anti-rotation features include teeth 168. The teeth 168 are depicted at a bottom of the mounting positions 154A and 154C. The teeth 168 can define predetermined angles at which the post 136 can be angled with respect to the display 114. For instance, FIG. 8 depicts features, e.g., corners, of a first post 136A interfaced with a first set of teeth 168 at a first relative angle and features, e.g., corners, of a second post 136B interfaced with a second set of teeth 168 at a second relative angle. The corners of the post 136A and 136B can interface with the teeth 168 at different preset angles.

Referring again to FIG. 2, the display 114 may be rotatable about another axis in either second direction D₂. The display 114 may be rotatable in either second direction D₂ by at least 1°, such as at least 5°, such as at least 10°, such as at least 25°, such as at least 45°. The display 114 may also, or alternatively, be rotatable in either third direction D₃. The display 114 may be rotatable in either third direction D₃ by at least 1°, such as at least 5°, such as at least 10°, such as at least 25°, such as at least 45°. These directions may be referred to as pitch (e.g., direction D₁), roll (e.g., direction D₂), and yaw (e.g., direction D₃). By rotating the display 114 in either direction indicated by any one or more of directions D₁, D₂ or D₃, the display 114 can be adjusted to a desired orientation relative to the support stand 104.

In an embodiment, reorienting the display 114 in any one or more of directions D₁, D₂ or D₃ can include reconfiguring the display 114, reconfiguring the attachment mechanism 116 (e.g., selecting between a plurality of differently shaped or oriented engagement portions 124), reconfiguring the attachment between the display 114 and attachment mechanism 116 (e.g., selecting between different mounting positions 154), or any combination thereof. In some instances, reorienting the display 114 in any one or more of directions D₁, D₂ or D₃ can include plastic deformation of one or more elements of the system 100, e.g., of the post 136. For instance, the installer can bend the post 136 to a desired orientation, e.g., after coupling the display 114 to the attachment mechanism 116.

In an embodiment, the display 114 can include artwork, such as a two-dimensional relief, a three-dimensional relief, or any other object having artistic value. Exemplary displays with artistic value include sculptures and figurines, geographic representations such as an outline of a state or country, landscape depictions or landscape elements such as a tree, a human likeness, an animal likeness, two-dimensional art such as a painting or enameled art, a business logo, a sports logo, a university logo, one or more numerical or alphanumerical symbols such as zip codes, area codes, sports jersey numbers, license plate numbers, emojis, hashtags, names, usernames, or the like. In some instances, the artwork of the display 114 can extend from a generally planar background, i.e., as a relief. In other instances, the display 114 can include one or more discrete objects without a defined background, i.e., an object.

In an embodiment, the display 114 can include a plurality of sides. Artwork may be included on one of the sides, two of the sides, three of the sides, four of the sides, five of the sides, six of the sides, or more. In an embodiment, the display 114 can include a plurality of different sides each having a different appearance, e.g., different artwork. In certain instances, the display 114 may be reversible. For example, the display 114 may include a first design on a first side of the display 114 and a second design on a second side of the display 114. The display 114 may be repositioned relative to the support stand 104 to change which one of the different sides is viewable at a given time from a given vantage point.

For numerical and alphanumerical symbols, the characters may be arranged in a vertical orientation such that the symbols are read from top to bottom or from bottom to top, a horizontal orientation such that the symbols are read from left to right or from right to left, an arced configuration, a stepped configuration, or otherwise arranged to achieve a desired effect.

In some instances, the display 114, or a portion of the display 114, can be colored, e.g., painted or enameled, laser imprinted, sublimated, dyed, or the like. The display 114 can be single colored or multi-colored. In an embodiment, the display 114 can have a layered construction including a plurality of lamina forming a strata. By way of non-limiting example, each lamina can have a layer thickness in a range of between and including 0.005 mm and 0.5 mm. In some instances, the display 114 can have a stepped-edge outer surface revealing the strata, or indicia of a strata. In other instances, the display 114 can have a smooth or textured, i.e., non-stepped, outer surface.

By way of non-limiting example, the display 114 can be formed by stamping, casting, forging, rolling, extrusion, cutting, pressing, milling, turning, drilling, tapping, welding, additive manufacturing, injection molding, rotational (roto) molding, blow molding, engraving, vapor deposition, another suitable method, or any combination thereof. In certain instances, the display 114 can be formed by shaping a green body which is hardened to a solid, e.g., by heat treatment, pressure treatment, or another suitable method. In an embodiment, the display 114 and attachment mechanism 116 can be formed by different processes. For example, the display 114 may be cast epoxy and the attachment mechanism 116 can be pressed sheet metal.

The display 114 can be configured to operate at elevated temperatures which may be encountered at locations adjacent to the engine and exhaust structures of the motorcycle 102, such as for example, at temperatures of at least 150° F., such as at least 175° F., such as at least 200° F., such as at least 250° F., such as at least 300° F. In one or more instances, the display 114 can be heat treated.

In an embodiment, the display 114, or a portion thereof, can be formed from a relatively hard material. For example, the display 114 can be formed from a material having a shore D hardness of at least 30, such as at least 40, such as at least 50, such as at least 60, such as at least 70, such as at least 80, such as at least 90. In another embodiment, the display 114, or a portion thereof, can be formed from a relatively flexible material having a shore OO hardness of less than 80, such as less than 70, such as less than 60, such as less than 50, such as less than 40, such as less than 30, such as less than 20. In certain instances, the display 114 can include portions formed from materials having different relative hardness. For example, in an embodiment the display 114 can include a first portion having a shore D hardness of at least 30 and a second portion having a shore OO hardness no greater than 80.

In one or more embodiments, the display 114 can be formed from a metal or a metal alloy. Exemplary metals include aluminum, steel, and zinc. Exemplary alloys include brass, cast iron, pewter, and stainless steel. In another embodiment, the display 114 can be formed from a plastic material. Exemplary plastic materials include acrylic or polymethyl methacrylate (PMMA), polyoxymethylene (POM), polycarbonate (PC), polyethylene (PE), polypropylene (PP), polyethylene terephthalate (PETE or PET), polyvinyl chloride (PVC), acrylonitrile-butadiene-styrene (ABS), poly(p-phenylene oxide) (PPO), poly-p-phenylene ether) (PPE), polybutylene terephthalate (PBT), polysulfone (PSU), polyphenylene sulfide (PPS), liquid crystal polymer (LCP), thermoplastic polyimide (TPI), polyamide-imide (PAI), polyether ether ketone (PEEK), or the like. In yet another embodiment, the display 114 can be formed from a cured resin, such as an epoxy resin. Exemplary epoxy resins include bisphenol epoxy, aliphatic epoxy, novolac epoxy, halogenated epoxy, epoxy resin diluents, glycidylamine epoxy, or the like.

In some embodiments, the display 114 can include one or more fillers. Exemplary fillers include glass fibers, carbon fibers, silicon, PEEK, aromatic polyester, carbon particles, bronze, fluoropolymers, thermoplastic fillers, aluminum oxide, polyamidimide (PAI), PPS, polyphenylene sulfone (PPSO2), liquid crystal polymers (LCP), polyether ether ketones (PEEK) aromatic polyesters (Ekonol), aromatic polyesters, molybdenum disulfide, tungsten disulfide, graphite, grapheme, expanded graphite, boron nitrade, talc, calcium fluoride, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof.

In an embodiment, the display 114 can have a generally homogenous composition. For example, the display 114 can be milled from a single billet or molded using a generally singular composition. In another embodiment, the display 114 can have a heterogenous composition. For example, the display 114 can include an epoxy with a loosely mixed filler, such as a carbon fiber filler. In some instances, the filler can form striations along a surface of the display 114. The striated filler may be visible. The striated filler may enhance perceived depth of the display 114.

In an embodiment, the display 114 can include one or more natural materials such as plants, stones, jewels, animal hides, animal products, or the like. In an embodiment, the display 114 can include one or more reflective objects such as reflective tape or a luminescent portion, one or more light emitting devices such as one or more LEDs, one or more noise generators or whistles, a special effects generator such as a steam generator, a sensor, or the like.

In an embodiment, the display 114 can include a receiving area (not illustrated) which can receive, for example, a tool associated with coupling the display 114 to the support stand 104. For instance, the display 114 can include a slot to receive an allen wrench or a screwdriver for adjusting the fastener 150. The receiving area can be positioned so as to be at least partially hidden from view.

In an embodiment, the display 114 can include an attachment area (not illustrated) to receive an attachment (not illustrated). By way of non-limiting example, the attachment can include secondary artwork (e.g., a secondary three-dimensional object) that adds to the display 114; an informational plate with information pertaining to a particular business, location, person, or the like; a cover like a rain cover or anti-theft barrier; or the like. The attachment can be coupled to the display 114, e.g., removably coupled to the display 114. In this regard, each display 114 can be customized using a unique attachment. The attachment area can be disposed on a front side of the display 114, along the rear surface 150, or at another location of the display 114.

In an embodiment, the display 114 can be selected from a group of displays each having a different design. The current display 114 coupled to the attachment mechanism 116 can be quickly swapped to a display having a different design, for example, by removing the fastener 150, swapping displays, and recoupling the fastener 150 to the attachment mechanism 116. The rider can thus select between different designs and quickly change the display 114 as desired. More particularly, and as noted above, this process can be non-destructive.

In some instances, the display 114 may provide functional assistance to the rider. For example, the display 114 can be used by the rider to move the support stand 104 between the stored and in-use positions. That is, the rider may engage the display 114 to bias the support stand 104. This may be particularly advantageous for shorter riders struggling to reach an existing projecting peg of the support stand 104. In an embodiment, the display 114 is not intended to support weight of the support stand 104, i.e., the display 114 is not disposable below the support stand to support the motorcycle 102. It should be understood that traditional motorcycle support pads upon which support stands 104 can be rested have no artistic value. In an embodiment, the display 114 may include a removable portion which includes a support pad that can be used below the support stand 104 to support the motorcycle 102.

Referring to FIG. 9, the display 114 can include an opening 170 configured to receive an object which extends from the support stand 104. For instance, the opening 170 can receive a projecting peg which projects from the support stand 104. In an embodiment, the opening 170 can extend from the rear surface 152 of the display 114. In some instances, the opening 170 can extend through an entire thickness of the display 114. In other instances, the opening 170 can terminate within the display 114.

In an embodiment, the display 114 can include a cutout 176 (FIG. 2) which accommodates one or more features, e.g., a bumper 178, of the support stand 104 to allow the display 114 to be mounted adjacent to the one or more features. By way of non-limiting example, the cutout 176 can be disposed at an outer surface of the display 114 and form a recess extending into the display 114.

As described above, the display 114 may be adjustably positioned relative to the support stand 104 during installation to accommodate support stands 104 of various shapes and sizes. In this regard, the system 100 can be universal and allow for attachment to a wide range of vehicles. In accordance with some embodiments, the system 100 can have a static relationship with respect to the support stand 104 once the system 100 is coupled to the support stand 104. In accordance with other embodiments, the system 100 can have a dynamic relationship with respect to the support stand 104 to allow relative movement between one or more components of the system 100 and the support stand 104.

FIG. 12 illustrates a side view of the motorcycle 102 as seen in FIG. 1 with the support stand 104 in the stored position. The display 114A is positioned as seen in FIG. 1 in a static relationship with the support stand 104. In this regard, the display 114A remains at a same relative position with respect to the support stand 104 regardless of the position of the support stand 104. A second display 114B is shown at an adjusted position. The second display 114B may be dynamically moveable with respect to the support stand 104 between two or more relative positions. Dynamic movement is intended to refer to relative movement exhibited when the system 100 is installed on the support stand 104 and not degrees of freedom (DOF) permissible during installation as described above. For instance, the display 114B may be disposed at a same location as the display 114A when the support stand 104 is in the in-use position but move to the adjusted position when the support stand 104 is in the stored position. In certain instances, the display 114B can move between the first and adjusted positions without requiring rider input.

To facilitate movement of the display 114B relative to the support stand 104, the display 114B may be dynamically, i.e., moveably, coupled to the attachment mechanism 116, the attachment mechanism 116 may be dynamically coupled to the support stand 104, either of the display 114B or attachment mechanism 116 can include an internally dynamic component to allow relative movement of the display 114B or attachment mechanism 116, or a combination thereof. By way of non-limiting example, the attachment mechanism 116, e.g., the post 136, can include a track 172 (FIG. 12) in lieu of the nut 148. The track 172 can project from the post 136. The track 172 can be curved about an axis of curvature oriented generally parallel with the longitudinal axis A_{L} of the support stand 104. Instead of the fastener 150 (FIG. 6) securing the display 114A statically to the post 136, the display 114B can ride along the track 172 between a first position corresponding with the location of the display 114A and the adjusted position corresponding with the location of the display 114B. In certain instances, the amount of displacement between the first and adjusted positions can be tuned and controlled. For example, the track 172 may include a stop 174 which can be adjusted along a length of the track 172. The stop 174 can be positioned at one or more preset stop locations or infinitely adjustable along the track 172. The display 114B can ride along the track 172 until reaching the stop 172.

To facilitate movement of the display 114B between the first and adjusted positions, the display 114B can be weighted, spring biased, or the like. Moreover, the track 172 can be helical or otherwise shaped to promote movement of the display 114B based on orientation of the support stand 104. In some instances, dynamic movement between the display 114B and the support stand 104 is simple (i.e., involving only one type of displacement). In other instances, dynamic movement between the display 114B and the support stand 104 is complex (i.e., involving a plurality of different movement types). For example, as depicted in FIG. 12, the display 114B undergoes complex movement by both translating in a direction of the longitudinal axis A_{L} and rotating about an axis of rotation oriented parallel with the longitudinal axis A_{L}. Yet other dynamic movements can involve any one or more of a change in pitch, a change in yaw, a change in roll, an internal movement occurring within the display 114B itself, or the like. The above exemplary embodiment is not intended to be limiting. By way of non-illustrated example, dynamic movement between the display 114B and the support stand 104 can be facilitated at least in part by a motor, a magnet, a ground-engaging element which biases the display 114B when the support stand 104 is rested on the ground, a vehicle-engaging element which biases the display 114B when the support stand 104 is brought to the stored position, or the like.

Through the use of dynamic engagement between the display 114B and the support stand 104, the display 114B may be visible at all times in one or more desired orientations. In certain instances, the display 114B can be configured to show different visual aesthetics when in the adjusted position as compared to the first position. For example, the display 114B can display a first artwork when at the first position and a second artwork when at the adjusted position.

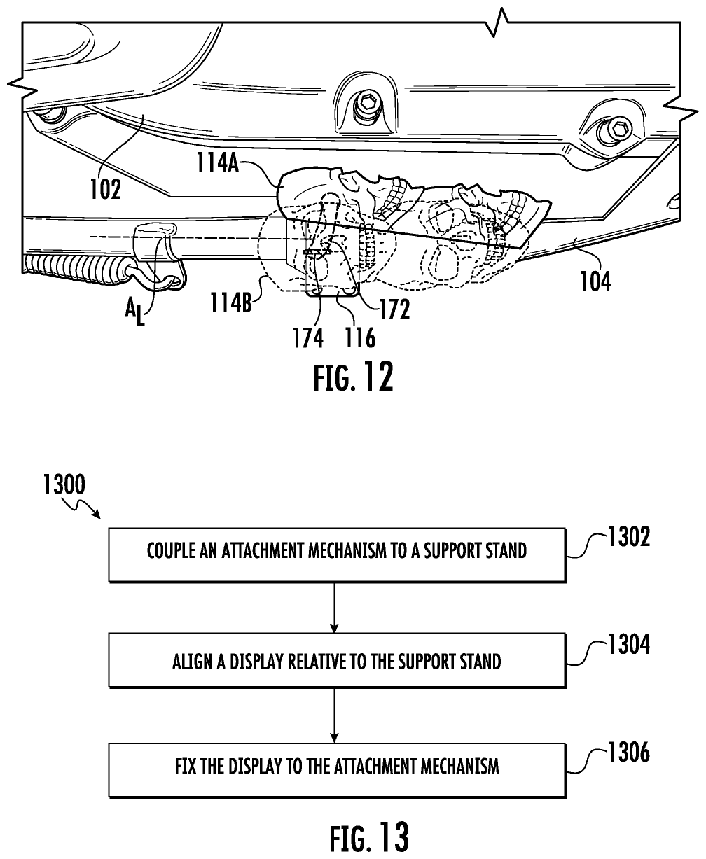

FIG. 13 depicts a flowchart of a method 1300 of installing a system having a display on a support stand. The method 1300 includes a step 1302 of coupling an attachment mechanism of the system to the support stand. In some instances, the step 1302 can be performed without the display. For example, the attachment mechanism can be positioned at a desired location along the support stand and fixed at the desired location. In other instances, the step 1302 can include the use of the display. For example, it may be desirable to dry fit the display relative to the support stand prior to fixing the attachment mechanism to the support stand. This may allow the installer to better estimate, test and realign the display until it is positioned at the desired location. In some instances, the display can be coupled to the attachment mechanism during dry fitting. This coupling may involve fully tightening the display to the attachment mechanism or loosely tightening the display to the attachment mechanism. In other instances, the display can be dry fit without requiring attachment to the attachment mechanism. For instance, the operator can dry fit the display with the attachment mechanism without fixing the two together. If the dry fit positioning is not desired, the installer can adjust the relative position of the attachment mechanism relative to the support stand. By way of non-limiting example, the installer can rotate the attachment mechanism about the support stand, translate the attachment mechanism about the support stand, internally adjust an aspect of the attachment mechanism, or the like.

The method 1300 can further include a step 1304 of aligning the display relative to the support stand. In some instances, the step 1304 of aligning the display can occur after completion of coupling the attachment mechanism to the support stand at step 1302. Alignment of the display relative to the support stand can include changing an orientation of the display about one or more axis, adjusting an aspect of the display itself, selecting a proper mounting position, or the like.

The method 1300 can further include a step 1306 of fixing the display to the attachment mechanism. In some instances, step 1306 of fixing the display to the attachment mechanism can occur after completion of the alignment step 1304. In other instances, the step 1306 of fixing the display to the attachment mechanism can occur prior to step 1302 of coupling the attachment mechanism to the support stand. In such instances, the display may be reoriented relative to the attachment mechanism after the attachment mechanism is coupled with the support stand.

In some instances, the installer may further adjust one or more aspects of the system to allow for, or adjust, dynamic movement between the display and support stand. By way of non-limiting example, the operator may adjust the position of the stop 174 relative to the track 172 in view of specific spatial constraints or desired movement patterns. The installer may also install one or more secondary attachments (e.g., a removable nameplate on the display), activate or attach one or more special effects associated with the system (e.g., a steam generator, a light emitter, or the like), set clearance for one or more actuating elements which assists with dynamic motion (e.g., one or more push rods which interface with the ground or motorcycle to affect motion of the display relative to the support stand), or the like. The installer may swap between different displays by uncoupling the display from the attachment mechanism and swapping the display with another display. In some instances, swapping of displays may occur without requiring the operator to move the attachment mechanism. For example, two or more of the displays having different designs can be designed such that each of the two or more displays stays within a common boundary.

While embodiments described above may utilize attachment mechanisms that are coupled to the support stand, in a non-illustrated embodiment, the attachment mechanism may also be at least partially integrated into the support stand. By way of non-limiting example, the support stand may include a post (e.g., similar to the aforementioned post 136) which extends from the support stand and interfaces with one or more displays. The displays can be interchangeably utilized with the at least partially integrated attachment mechanism to allow for swapping between different displays.

In certain instances, the post and mounting positions described herein can be reversed such that the display includes one or more posts and the attachment mechanism includes one or more mounting positions. In yet other instances, the post and mounting positions can be split between the display and attachment mechanism such that at least one of the display and attachment mechanism includes parts of the post(s) and parts of the mounting position(s). In an embodiment, the attachment interface between the attachment mechanism and display can be hidden from a primary viewing angle of the display (e.g., a front face of the display) when the display is coupled to the support stand.

While embodiments described above have been directed specifically to motorcycles, it should be understood that support stands are utilized in a wide variety of vehicles and that the teachings herein may be extended to include other vehicles, such as scooters, mopeds, bicycles, electric bicycles often referred to as e-bikes, and the like. Moreover, while the described embodiments reference support stands in particular, it should be understood that the systems described herein can be used to attach displays to structures associated with different objects. For example, scooters typically include a head tube extending vertically between a floorboard and a handlebar. The systems described herein can be coupled to the head tube. Bicycles often include upper tubes extending horizontally between a head tube and a seat tube. The systems described herein can be coupled to the upper tube. Golf carts typically include framework extending between a sitting area and a roof structure. The systems described herein can be coupled to the framework. By way of these non-limiting examples, it is proposed by the present disclosure to universally display artwork on objects, e.g., elongated bodies, while permitting easy installation and removal of the display relative to the object.

Further aspects of the invention are provided by one or more of the following:

In an embodiment, a system for coupling a display having artistic value to a support stand of a vehicle can include the display and an attachment mechanism configured to couple the display to the support stand, wherein the display is adjustably positionable relative to the support stand with at least three degrees of freedom.

In another embodiment, a system for coupling a display having artistic value to a support stand of a vehicle can include the display; and an attachment mechanism configured to couple the display to the support stand, wherein the display is selected from a plurality of displays each having a different appearance, and wherein at least two of the plurality of displays are configured to be coupled to the attachment mechanism without requiring movement of the attachment mechanism relative to the support stand.

In yet another embodiment, a system for coupling a display having artistic value to a support stand of a vehicle can include the display; and an attachment mechanism configured to couple the display to the support stand, wherein the display is adjustably positionable relative to the attachment mechanism with at least one degree of freedom, and wherein an interface between the display and attachment mechanism is disposed within an outer boundary of the display.

In a more particular embodiment, the display is adjustable relative to the support stand with at least three degrees of freedom, and the at least three degrees of freedom include at least one degree of freedom between the display and the attachment mechanism.

In another more particular embodiment, the attachment mechanism is at least partially integrated into the support stand, at least partially integrated into the display, or both.

In another more particular embodiment, the display is selected from a plurality of displays each having a different appearance, wherein each of the plurality of displays is configured to be coupled to the attachment mechanism without requiring movement of the attachment mechanism relative to the support stand.

In another more particular embodiment, the display is removable from the attachment mechanism while the attachment mechanism remains coupled to the support stand.

In another more particular embodiment, the attachment mechanism includes a first component and a second component movably coupled together at an interface, wherein the first and second components together define an interface portion configured to interface with the attachment mechanism.

In another more particular embodiment, the display includes a plurality of mounting positions, wherein the attachment mechanism is configured to be coupled to each of the plurality of mounting positions, and wherein a position of the display relative to the support stand is different for each of the plurality of mounting positions.

In another more particular embodiment, the display is adjustable relative to the attachment mechanism with at least one degree of freedom.

In another more particular embodiment, the attachment mechanism is at least partially integrated into the support stand.

In another more particular embodiment, the display comprises a reinforced polymer.

In another more particular embodiment, the display includes a plurality of mounting positions, wherein the attachment mechanism is configured to be coupled to each of the plurality of mounting positions, and wherein at least one of the mounting positions is laterally offset from a central location of the display in a width direction of the display.

In another more particular embodiment, the display is coupled to the attachment mechanism by a fastener that extends through a portion of the display and engages with a post of the attachment mechanism at a location within an outer boundary of the display.

In another more particular embodiment, the display is dynamically coupled to the support stand.

In another more particular embodiment, the system is usable on support stands that pivot between stored and in-use positions along both vertical and horizontal axis of rotation.

In another more particular embodiment, the attachment mechanism is removable from the support stand.

In another more particular embodiment, the attachment mechanism is configured to be coupled to the support stand before the display is coupled to the attachment mechanism.

In another more particular embodiment, the attachment mechanism includes: a first component; and a second component movably coupled to the first component.

In another more particular embodiment, the display includes a three-dimensional relief on a first side of the display and an attachment protocol for interfacing with the attachment mechanism on a second side of the display.

In another more particular embodiment, the display is configured to be coupled to the support stand and removed from the support stand in a non-destructive manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. (canceled)

2. (canceled)

3. (canceled)

4. A system for coupling a display having artistic value to a support stand of a vehicle, the system comprising:
the display; and
an attachment mechanism configured to couple the display to the support stand,
wherein the display is adjustably positionable relative to the support stand with at least three degrees of freedom, and wherein the display is removable from the attachment mechanism while the attachment mechanism remains coupled to the support stand.

5. (canceled)

6. (canceled)

7. A system for coupling a display having artistic value to a support stand of a vehicle, the system comprising:
the display; and
an attachment mechanism configured to couple the display to the support stand,
wherein the display is selected from a plurality of displays each having a different appearance, and wherein at least two of the plurality of displays are configured to be coupled to the attachment mechanism without requiring movement of the attachment mechanism relative to the support stand.

8. The system of claim 7, wherein the display is adjustable relative to the attachment mechanism with at least one degree of freedom.

9. The system of claim 7, wherein the attachment mechanism is at least partially integrated into the support stand.

10. The system of claim 7, wherein the display comprises a plurality of mounting positions, wherein the attachment mechanism is configured to be coupled to each of the plurality of mounting positions, and wherein at least one of the mounting positions is laterally offset from a central location of the display in a width direction of the display.

11. The system of claim 7, wherein the display is coupled to the attachment mechanism by a fastener, wherein the fastener extends through a portion of the display and engages with the attachment mechanism at a location within an outer boundary of the display.

12. The system of claim 7, wherein the display is dynamically coupled to the support stand.

13. The system of claim 7, wherein the system is usable on support stands that pivot between stored and in-use positions along both vertical and horizontal axis of rotation.

14. (canceled)

15. (canceled)

16. (canceled)

17. (canceled)

18. (canceled)

19. (canceled)

20. (canceled)
